(19) United States
(12) Patent Application Publication
(10) Pub. No.: US 2024/0362295 A1
(43) Pub. Date: Oct. 31, 2024

(54) PREPROCESSING TO REDUCE ANNEALING PROCESSOR SEARCH SPACE

(71) Applicant: Dell Products L.P., Round Rock, TX (US)

(72) Inventors: Brendan Burns Healy, Haddonfield, NJ (US); Miguel Paredes Quiñones, Campinas (BR); Ítalo Gomes Santana, Rio de Janeiro (BR)

(21) Appl. No.: 18/307,963

(22) Filed: Apr. 27, 2023

(51) Int. Cl. G06F 17/11

(52) U.S. Cl. CPC G06F 17/11

(57) ABSTRACT

One example method includes accessing a parameter space including a set of binary inputs for an unconstrained objective function. The set of binary inputs are solved at a CPU or GPU using an algorithm that is different from the unconstrained objective function to generate a target solution. A subset of the binary inputs is selected. The unconstrained objective function is solved using the selected subset of binary inputs to generate a solution for each of the selected subset of binary inputs. A maximum possible change for each of the selected subset of binary inputs is determined. The maximum possible change defines a subspace including related binary inputs that are located around each of the selected subset of binary inputs. Those binary inputs and their corresponding related binary inputs whose solutions are greater than the target solution are removed from the parameter space to thereby generate a reduced parameter space.

### FIELD OF THE INVENTION

Embodiments of the present invention generally relate to annealing processors. More particularly, at least some embodiments of the invention relate to systems, hardware, software, computer-readable media, and methods, for the use of preprocessing to reduce the search space of annealing processors when solving optimization problems.

### BACKGROUND

Annealing processors are capable of performing many types of computations, such as solutions to optimization problems, faster and more accurately than classical computation using a CPU or a GPU. However, notwithstanding their increased computing the current generation of annealing processors are often not advanced enough to provide an advantage over existing algorithms that are solved using a GPU or CPU.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a relation between energy and state of a quantum system.

FIG. 2 discloses aspects of a system for reducing the parameters that will be input into an annealing processor.

FIG. 3 discloses aspects of a method according to one embodiment.

FIG. 4 discloses an example computing entity, which may comprise a quantum computing entity with classical and/or quantum components, that is operable to perform any of the disclosed methods, processes, and operations.

### DETAILED DESCRIPTION OF SOME EXAMPLE EMBODIMENTS

Embodiments of the present invention generally relate to annealing processors. More particularly, at least some embodiments of the invention relate to systems, hardware, software, computer-readable media, and methods, for the use of preprocessing to reduce the search space of annealing processors when solving optimization problems.

In many technology stacks, it is the case that the optimal way to execute a workload is a combination of different software, hardware, and algorithms. In an era of increasing heterogeneity of compute, certain technologies are only now coming to maturity and able to be integrated into this landscape. The embodiments disclosed herein describe a way to leverage interplay between classical computation by Central Processing Unit (CPU) or Graphics Processing Unit (GPU) and annealing processors (whether digital, quantum, or otherwise). It is common to take output from an annealing processor and perform tweaks to the solution by standard hardware-so-called “classical postprocessing”, sometimes referred also to as “recovering feasibility”. This is often necessary because the current generation of annealing processor is not advanced enough to provide an advantage over existing algorithms. The embodiments disclosed herein provide for a novel preprocessing method, in which classical compute is leveraged to reduce the search space of the annealing processor prior to any computation by the annealing processor, thus improving both runtime and accuracy of the annealing processor.

One example method includes accessing a parameter space including a set of binary inputs for an unconstrained objective function. The set of binary inputs are solved at a CPU or GPU using an algorithm that is different from the unconstrained objective function to generate a target solution. A subset of the binary inputs is selected. The unconstrained objective function is solved using the selected subset of binary inputs to generate a solution for each of the selected subset of binary inputs. A maximum possible change for each of the selected subset of binary inputs is determined. The maximum possible change defines a subspace of the parameter space including related binary inputs that are located around each of the selected subset of binary inputs. Those binary inputs and their corresponding related binary inputs whose solutions are greater than or can be deduced to be greater than the target solution are removed from the parameter space to thereby generate a reduced parameter space.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that the speed and accuracy of the annealing processor can be improved such that the full compute capacity of the annealing processor can be used, thus providing better results than classical compute using the GPU or CPU. In an embodiment, the search space may be reduced by determining and then removing those parameters that will not provide results that are better than the results provided by the classical compute using the GPU or CPU. In other words, the full search space is “preprocessed” and the set of parameters not proving the better results are removed from the search space. The reduced set of parameters constitute a reduced search space that can then be input into the annealing processor for solution of the optimization problem. Since there are fewer parameters to compute, the speed and the accuracy of the annealing processor should be improved.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of An Annealing Processor

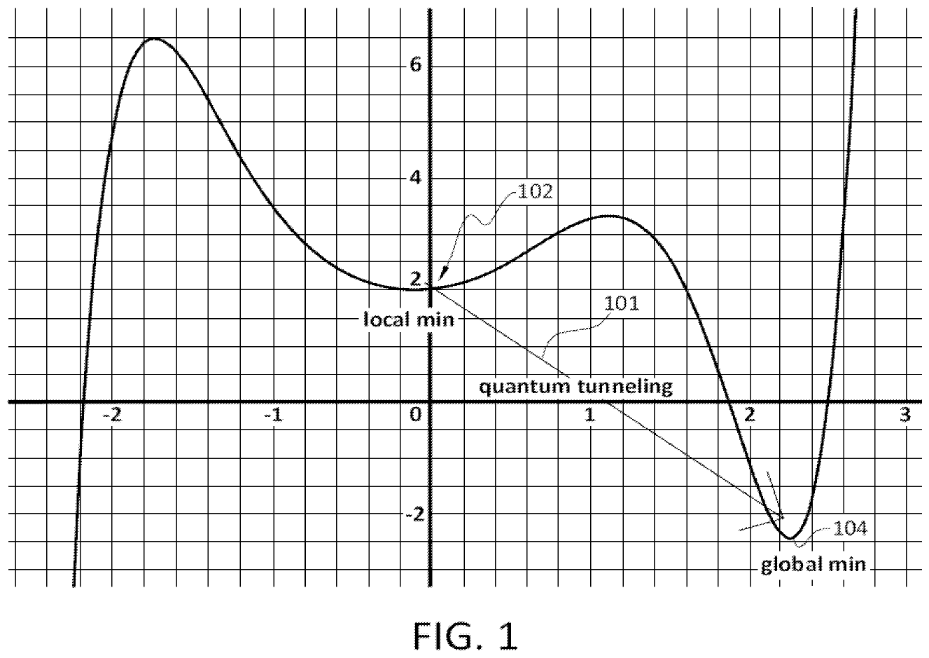

Annealing processors, such as D-Waves quantum annealers or a Fujitsu digital annealers work in a fundamentally different way than traditional processors. Rather than following the gate-based model of typical CPUs, annealing processors take advantage of principles of physics in order to determine optimal solutions for problems input by a user. To do this, the annealing processors translate the problem, variables, and constraints into a physical system, which translation may be heavily dependent on the processing unit in question. Then, under these conditions, the physical system is allowed to evolve naturally. Taking advantage of the principle of minimum energy, any such system will eventually settle into a state that minimizes overall energy. Avid students of physics or mathematics may protest here, noting the difference between local and global minima, but this may be handled differently depending on the hardware involved. For example, quantum systems take advantage of quantum tunneling, as shown in the graph 100 of FIG. 1, which discloses quantum tunneling 101 moving, in terms of energy level, measured on the Y-axis denoted ‘Potential,’ from a local minimum 102 to the global minimum 104.

Annealing processors are particularly well suited to optimization problems, as the energy of the final state of the system will represent a single, floating point output, or solution, to the problem, which is the minimum over the search space, keeping in mind that for maximization problems, a minus sign may be introduced. The interface for annealing processors may output this energy value, as well as the parameters that give rise to it, and the solution may be checked using a classical processor if desired. Furthermore, this interface may also be able to list the constraints which were placed on the inputs to the problem that was to be solved.

Annealing processors, similar to gate-based quantum computers, may still be considered as ‘noisy’ in the sense that external conditions may impact the computation. Outside of a perfect vacuum, it is impossible to guarantee 100% fidelity for every computation. For this reason, jobs on these kinds of hardware are often done iteratively, such as 10 or 100 times for example. While the sum total of outputs may be of interest to the user, oftentimes the “best” lowest energy solution is reported back as the answer. This answer may be arrived at multiple times over the course of the iterations performed, and it is possible that the same minimal energy state, or solution, may be obtained by using multiple different sets of inputs.

If no viable solutions exist, the annealer will not fail to return an output, but rather it will return the solution which least violates the constraints. This may be somewhat subjective, but in the implementation of the problem, the user has the ability to place the value and importance of each constraint numerically, in a process referred to as weighting.

### A1. QUBO Format

Annealing processors, when evaluating any problem, rely on it being converted into a specific format to allow it to be executed on this highly specialized kind of hardware. This kind of problem is called a Quadratic Unconstrained Binary Optimization (QUBO) problem. These problems involve Optimizing a Quadratic polynomial in some number of variables that are Binary (can take on only the value 0 or 1), and are Unconstrained (all may be 1, all may be 0, etc.).

One mathematical formulation of this problem is shown below, where Q represents a matrix containing the coefficients of a degree two polynomial in variables x₁, the vector of which is x.

$${min}_{x ∈ {\{ 0 , 1 \}}^{n}} {x}^{T} Qx$$

An example of such a problem will now be explained. Consider two binary variables x₁ and x₂, and the quadratic polynomial P (x₁, x₂). It is desired to determine what the minimal value of P is over the possible inputs, {(0,0), (1,0), (0,1), (1,1)}. Note that if one wishes to maximize a particular value instead, the polynomial P may simply be multiplied by −1. Suppose P=−3x₁−5x₂+10x₁x₂. Notice there is no lack of generality in the absence of x₁² or x₂² terms —however, observe that no matter whether xᵢ is 0 or 1, it is true that xᵢ²=xᵢ, so αxᵢ+bxᵢ² may be rewritten as (α+b)xᵢ.

Solving the problem for the possible imputes results in: P(0,0)=0, P(1,0)=−3, P(0,1)=−5, P(1,1)=+2. Therefore, the optimal solution arises from x₁=0, x₂=1.

### A2. Integer Representation

QUBO optimization deals only with binary variables, but there is also interest in representing integers within certain ranges to model more general integer problems. For this purpose, various methods for encoding an integral variable into binary exist, including, but not limited to, Logarithmic encoding, Unary encoding, and one hot encoding. An example using Logarithmic encoding will now be explained. It will be understood, however, that the principles shown in the Logarithmic encoding example also apply to the other forms of encoding.

Suppose there is an integer variable X in the problem to be solved, which can take on any value from 0 to Xₘₐₓ, inclusive. However, as mentioned above annealing processors only natively supports the data type ‘binary’, so a formalism is created to translate X into a combination of binary variables every time X is referenced, which is usually in the form of adding X to a constraint or objective function. In the following expression, xᵢ will refer to natively supported binary variables.

$$X = {\sum }_{i = 0}^{N} {x}_{i} \cdot {2}^{i} + ( {X}_{max} + 1 - {2}^{N + 1} ) \cdot {x}_{N + 1}$$

where: N=[log₂(Xₘₐₓ+1)]−1 and each xᵢ is either 0 or 1. Note that the coefficient of the last one is only as large as it needs to be to hit the top end of the range Xₘₐₓ, when all binary variables equal 1, and is not a power of two, unless the range ends in one less than a power of two.

### B. Aspects of Parameter Space Reduction

As mentioned previously, in some instances an annealing processor fails to solve a problem such as an optimization problem in a way that provides any advantage in terms of speed and accuracy over solving the problem using a CPU or GPU. That is, the performance of the annealing processor solution when compared to the performance of the CPU or GPU solution (not in QUBO format) does not justify the increased cost of implementing the annealing processor. It has been observed that the largest obstacle to obtaining faster performance from the annealing processor is the size of the search space or the number of parameters (also known as q-bits or binary inputs) that are input into the annealing processor. Thus, although the annealing processor should be able to solve a large optimization problem faster and with more accuracy than CPU or GPU, if the size of the search space is so large that the execution time becomes significantly larger than that of the CPU or GPU, then any advantage of using the annealing processor may be lost. Said another way, if the execution time is significantly larger than that of the CPU or GPU, then a user may be willing to accept the less accurate solution provided by the CPU or GPU in order to achieve the faster execution time. Thus, the user trades accuracy for speed.

Advantageously, the embodiments disclosed herein provide for a way to reduce the search space or the number of parameters input into the annealing processor using a preprocessing system and method. The preprocessing system and method determines an acceptable solution using a CPU or GPU as a target solution. The preprocessing method then compares the target solution to the solution using randomly selected parameters of the search space and removes those parameters that will not produce a better solution than the target solution. This results in a reduced number of parameters being input into the annealing processor, which should result in obtaining the more accurate solution provided by the annealing processor in an acceptable amount of time.

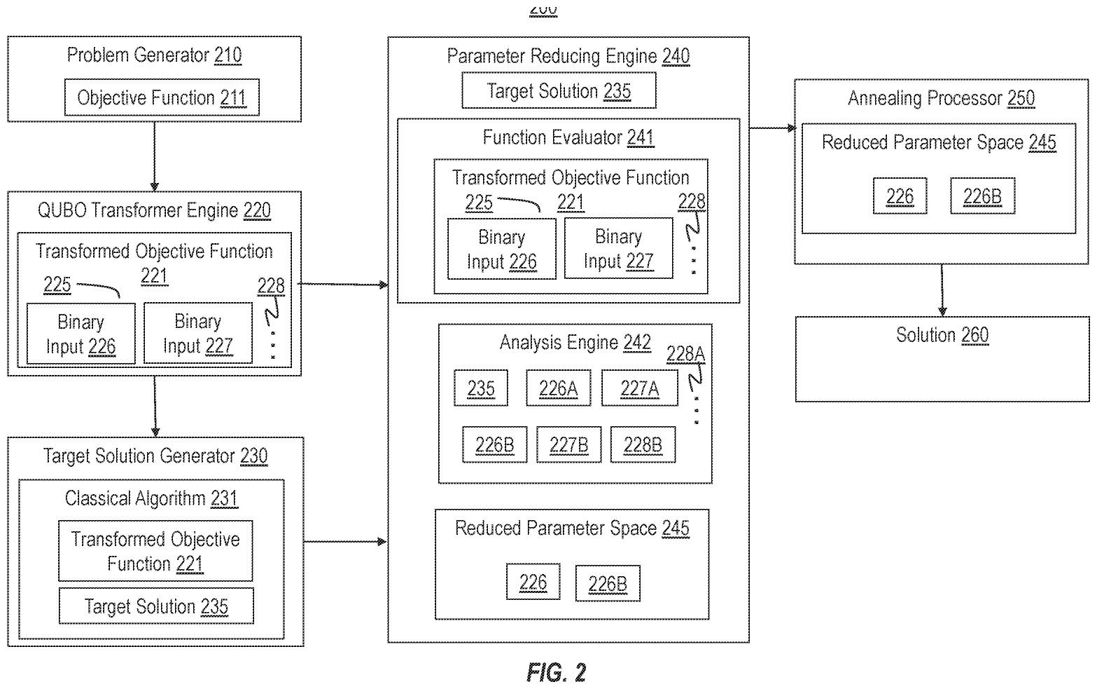

FIG. 2 illustrates an embodiment of a system 200 for reducing the parameters that will be input into an annealing processor 250. It will be appreciated that a problem generator 210, a QUBO transformer engine 220, a target solution generator 230, and a parameter reducing engine 240 are implemented on a classical CPU or GPU. These elements may be implemented on the same CPU or GPU of a computing system or they may be implemented on separate CPUs or GPUs of different computing systems as circumstances warrant.

As illustrated, the system 200 includes the problem generator 210. In operation, the problem generator 210 is configured to define a problem to be solved, which is also referred to as an objective function 211. For example, suppose that a project manager has $1,000,000 to spend on two projects, but can only spend up to $750,000 on a given project. The project manager wants to achieve the highest return on the spending on the project. The $750,000 limit may be considered a hard constraint on the problem since $750,000 is a ceiling on the amount that can be spent on one project and any solution that uses more than $750,000 as an input would not be valid. Other inherent constraints such as the types of available projects to fund or the historical return on spending for a project might also be present. Accordingly, problem generator 210 is able to generate the problem as the objective function 211 that also takes into account any constraints.

The system 200 also includes the QUBO transformer engine 220. In operation, the QUBO transformer engine 220 is configured to transform the objective function 211 into a transformed objective function 221. That is, the integer variables of the objective function 211 are transformed into binary variables. This transformation may be done using a logarithmic encoder or one of the other encoders as previously described. The resulting transformed objective function 221 will have a parameter or search space 225 that includes the set of possible inputs for each of the binary variables that can be used to solve the problem. The number of binary variables will be dependent on the number of integer variables found in the objective function 211. For example, as previously described the quadratic polynomial P (x₁, x₂) has two binary variables (x₁, x₂) and has a parameter or search space 225 that includes the four possible binary inputs for each of the binary variables, namely {(0,0), (1,0), (0,1), (1,1)}. In the embodiment, the parameter or search space 225 includes a binary input 226, a binary input 227, and any number of additional binary inputs 228 as illustrated by the ellipses.

The system 200 also includes the target solution generator 230. In operation, the target solution generator 230 receives or otherwise accesses the transformed objective function 211 from the QUBO transformer engine. The target solution generator uses a classical algorithm 231 to solve the transformed objective function 211 to generate a target solution 235. It will be appreciated that the classical algorithm may be any algorithm that is able to solve the transformed objective function 211 and that can be performed by the target solution generator 230.

The target solution 235 is a solution that is obtained relatively fast. For example, in some embodiments the target solution generator may generate the target solution in one to two minutes or less. The target solution also represents an acceptable estimated solution to the transformed objective function 211. That is, the target solution 235, while perhaps not being the ultimate best solution, is one that is acceptable given the speed in which it was generated. The target solution 235 can then be used as a benchmark when determining if other solutions are greater than the target solution and thus cannot represent a minimum when solved by the annealing processor 250.

For example, using the above example of the project manager spending on a project to obtain the highest return, suppose that the target solution generator 230 found, when solving the problem for possible inputs, that if $500,000 was spent on the project, the company would see a $5,000,000 return. In this case, target solution 235 would be that $500,000 spent on the project would produce the highest return. Of course, given the nature of the classical algorithm 231, it is possible that a different input would actually produce the highest return, but the target solution 235 is deemed acceptable and can be used as the benchmark as will be explained in more detail.

The system 200 includes a parameter reducing engine 240. In operation, the parameter reducing engine 240 receives or otherwise accesses the target solution 235 and the transformed objective function 221 along with its associated parameter space 225. A function evaluator 241 is configured to select a number of parameters in the parameter space 225 to solve. In other words, the function evaluator selects possible binary inputs for each of the binary variables that can be used to solve the transformed objective function 211. The selected parameters may be randomly selected in some embodiments. Alternatively, they may be selected intelligently. For example, the selected parameters may be selected in a given range of the input parameters so as to test the binary inputs more fully in that range. The number of the parameters selected, as well as if they are selected randomly or intelligently, is based on the transformed objective function 211. In the embodiment, the binary input 226, the binary input 227, and at least one of the additional binary inputs 228 are selected and evaluated, resulting in a solution 226A, 227A, and 228A.

The parameter reducing engine 240 includes an analysis engine 242 that performs various operations on the solutions 226A, 227A, and 228A. The purpose of the operations is to determine if the solutions 226A, 227A, and 228A are greater than the target solution 235. As mentioned above, if the solutions 226A, 227A, and 228A are greater than the target solution 235, they cannot represent a minimum when solved by the annealing processor 250

There may be many different operations performed by the analysis engine 242 when determining which of the parameters to remove from the parameter state. For example, in one embodiment to be explained in more detail to follow, the analysis engine 242 may take a derivative to determine a maximum possible change for a given binary input. In addition, the analysis engine 242 may take the difference between the solutions 226A, 227A, and 228A and the target solution 235 and may then divide by the maximum possible change to find a range of related parameters located in a subspace of the parameter space around the parameters used to produce the solution that can also be removed. In some embodiments, this analysis may include flipping one or more bits of the bit array forming the binary inputs to find the range.

For example, FIG. 2 shows a parameter subspace 226B that represents all the related binary inputs that are located around binary input 226 within the range defined by the maximum possible change of the binary input 226. A parameter subspace 227 represents all the related binary inputs that are located around binary input 227 within the range defined by the maximum possible change of the binary input 227. A parameter subspace 228 represents all the related binary inputs that are located around the additional binary inputs 228 within the range defined by the maximum possible change of the additional binary inputs 228. How the maximum possible change and the related parameter subspace are determined will be explained in more detail to follow.

Accordingly, for any such solutions that are greater than the target solution, the parameters of that solution (i.e., the binary inputs causing the solution) and the related binary inputs in the subspace of the parameter space can be removed from the parameter space. That is, there is no need to provide these parameters to the annealing processor 250 since they will not lead to an optimum solution.

As shown in FIG. 2, the result of the operations of the analysis engine produces a reduced parameter space 245. As illustrated, the reduced parameter space 245 only includes the binary input 226 and the related binary inputs 226B, thus showing that the binary input 227, the related binary inputs 227B, the additional binary inputs 228, and the related binary inputs 228B have been removed from the parameter space.

Using the example of the project manager, the function evaluator may randomly or intelligently select an input of $450,000 and $300,000 and then find their solutions. In addition, the analysis engine 242 may determine the if the solution for the inputs $450,000 and $300,000 is greater than the $500,000 target solution. In other words, does the solution for $450,000 and $300,000 return a larger return than the $5,000,000 of the $500,000 target solution. If not, then these inputs can be removed from the parameter space. In addition, a maximum change may be determined that defines a range around $450,000, for example $440,000 to 449,999 and 450,001-$460,000, of related inputs. The related inputs are also analyzed and removed if the input $450,000 is removed. In this way, the parameter space is reduced.

The reduced parameter space 245 is then provided to the annealing processor 250, where the binary inputs of the parameter space are used as inputs for solving the transformed objective function. A solution 260 is then generated, which will likely include a solution that is better than the target solution 235. In any case, since the parameter or search space has been reduced, the speed with which the annealing processor can solve the objective function for all inputs in the parameter space should be increased and the accuracy of the result should also be increased.

### B1. Example Analysis

Consider an arbitrary QUBO problem with binary inputs ({x₁, . . . , xᵢ, . . . xₙ}). A note on notation: x̅ is a vector of n bits, while x is an individual bit. These binary inputs will be the universe of values that the annealing processor 250 will search, regardless of whether more stringent constraints are put on these variables in the form of penalties on the objective function. The number of variables and total parameter space is now fixed at this point. Adding additional constraints to the problem via the objective function will not affect execution time. Thus, if one hopes to speed up the annealing process, the problem must be reformalized to reduce the parameter space, either by size or number of variables.

Let x̅=<x₁, . . . , xₙ>, and denote the objective function by f(x̅). What is first done is to determine the maximum change in f if a bit xᵢ is flipped. Because the problem is a QUBO function, linear (xᵢ²=xᵢ when xᵢ∈{0,1}) and constant terms (all solutions are translated by same value) can be ignored, and it can be assumed that f has the form

$$f ( \{ \overline{x} \} ) = {Σ}_{i \leq j} {C}_{i , j} {x}_{i} {x}_{j} .$$

In this embodiment, because it is desired to figure out how large of a change is possible to obtain when changing xᵢ from zero to one or vice versa, for each variable xᵢ, the partial derivative of f with respect to xᵢ can be formed. The following notation will be used:

$$\frac{\partial f}{\partial {x}_{i}} = : {f}_{i} .$$

Now, because f is quadratic, each fᵢ will be linear. Observe that any term of the form Cxⱼxₖ, where neither j nor k is i, will go to zero, and that any term of the form Cxᵢxₖ will be differentiated into Cxₖ, and ∂xᵢDxᵢxᵢ=2Dxᵢ. Thus, for any index, fᵢ=ΣⱼDⱼxⱼ. Denote by Mᵢ=Σⱼ|Dⱼ|∈ [symbol] . Observe that Mᵢ represents the maximum possible change in f when flipping the bit xᵢ.

As previously described, a fast, heuristic, and/or classical algorithm is applied to the problem to obtain a quick but acceptable solution to the considered problem. This is the target solution 235, denoted by f({x̅₀})=L₀. The purpose of this target solution is the ability to throw out any potential solutions which are greater than L and thus cannot represent a minimum.

Next, some m random samples of the parameter space are taken and their f values are checked. Label these m points {x̅ᵢ} with corresponding f values for Lᵢ. Because these points were chosen at random, it is expected generically that Lᵢ>L₀. In the unlikely event this is not the case, make the lowest L; the new target value (i.e., swap the roles of x̅₀ and x̅ᵢ).

LᵢLᵢ−L₀>Mⱼ1≤j≤nx̅₀xⱼLᵢ−L₀≤Mⱼ∀1≤j≤nx̅₀Lᵢ−L₀>max_{j≠k}{Mⱼ+Mₖ|1≤j<k≤n}x̅ⱼ For each, the following key fact is observed: If it is true that for any, then the optimal solution to the problem cannot obtained by taking and flipping bit. Furthermore, if, then the optimal solution does not differ from by any single bit. Continuing in this vein, it is observed that if, the optimal solution does not differ from by any two bits, etc.

LᵢLᵢ−L₀>Mⱼ1≤j≤nx̅₀xⱼLᵢ−L₀>Mⱼ∀1≤j≤nx̅₀Lᵢ−L₀>max_{j≠k}{Mⱼ+Mₖ|1≤j<k≤n}x̅ⱼ Then for induction the following set can be defined:

Ω_{k,x̅j}={\tilde{x}|members of the parameter space which differ from x̅ⱼ by at most k bits}

Observe that for any x̅ⱼ|Ω_{k,x̅j}|=2C^{k} and represents, for the correct k, a subspace of the parameter space that can effectively be deleted. After removing these bubbles around the random points, the new search space has the following form, where Ω is the original, unaltered parameter space. Assume here that kⱼ is the appropriate integer depending on the target solution L₀ and the value of f(x̅ⱼ).

$$\tilde{Ω} = Ω ∖ ( {{⋃}_{j = 1}}^{m} {Ω}_{\overline{{x}_{j} , {k}_{j}}} )$$

Thus, checking these simple inequalities can dramatically reduce the parameter space that needs to be evaluated by the annealing processor 250.

### B.1.1 Specific Example

A specific example of a scenario where the system and method disclosed herein reduce the parameter space the annealing processor 250 has to consider is shown. The scope of this example is intentionally small in order for it to be illustrative of the embodiments disclosed herein.

Consider a problem with five binary variables {x₁, . . . , x₅}, which would lead to a total parameter space of 32 since each of the binary variables can be a 0 or 1. If the objective function is f, suppose that the sum of the coefficients of ∂f/∂xᵢ were less than 10 for each i. That is, 10 represents a distance that is at most 10 away from particular solution of f where a maximum change is seen. As discussed above, this helps determine a range or space around the particular solution in the parameter space where potentially a better solution than the target solution may be found. Further suppose that target solution 235 had a value of f ({x_{target}})=−38=L₀.

Next, a random element of the parameter space is selected. For this example, x̅=(1,1,1,1,1) will be used simply because it is easiest to illustrate with, but any element of the parameter space would work in principle the same way, using modular arithmetic. Suppose it was found that f ((1,1,1,1,1))=0 when evaluated by the function evaluator 241. So then, 0−k*10<−38 is not true for any integral k less than 4, where k is the number of bits that define the range in the parameter space around the input array of the solution where maximum change can occur. Thus, it is known that in order to go from the point (1,1,1,1,1) to a solution that could be potentially better than the target solution, at least 4 bits must be flipped by the analysis engine 242. That is, to potentially find a solution that is better than the target solution, 4 steps away from the point (1,1,1,1,1) must be taken in the parameter space. Any parameters that are less than 4 steps away can be removed from the parameter space as these will not find a solution that is better than the target solution and so do not need to be provided to the annealing processor 250.

Put another way, there is now only a need to explore a parameter space that has at most one 1. So P={(0,0,0,0,0), (1,0,0,0,0), (0,1,0,0,0), . . . (0,0,0,0,1). There are six such inputs, so there is only a need for three binary variables now to encode the parameter space. The problem can thus be reparametrized with (Z₁, Z₂, Z₃) and the following correspondence can be created:

$$〈 0 , 0 , 0 〉 ⇔ ( 0 , 0 , 0 , 0 , 0 ) , 〈 1 , 0 , 0 〉 ⇔ ( 1 , 0 , 0 , 0 , 0 ) , … , 〈 0 , 1 , 1 〉 ⇔ ( 0 , 0 , 0 , 0 , 1 )$$

This would then define the new objective function:

$$\overline{f} ( 〈 {z}_{1} , {z}_{2} , {z}_{3} 〉 ) := f ( ( {x}_{1} , {x}_{2} , {x}_{3} , {x}_{4} , {x}_{5} ) )$$

It will be noted that the new objective function can then be provided to the annealing processor for further analysis to determine the solution 260 that is the optimal solution to the problem. As noted above, there are only six inputs for the binary variables of the new objective function. Since there were originally 32 inputs for the binary variables before the objective function was subjected to the principles of the embodiments disclosed herein, the parameter space has been reduced to a quarter of its original size. This smaller parameter space will result in increased speed and accuracy for the annealing processor 250.

### C. Example Methods

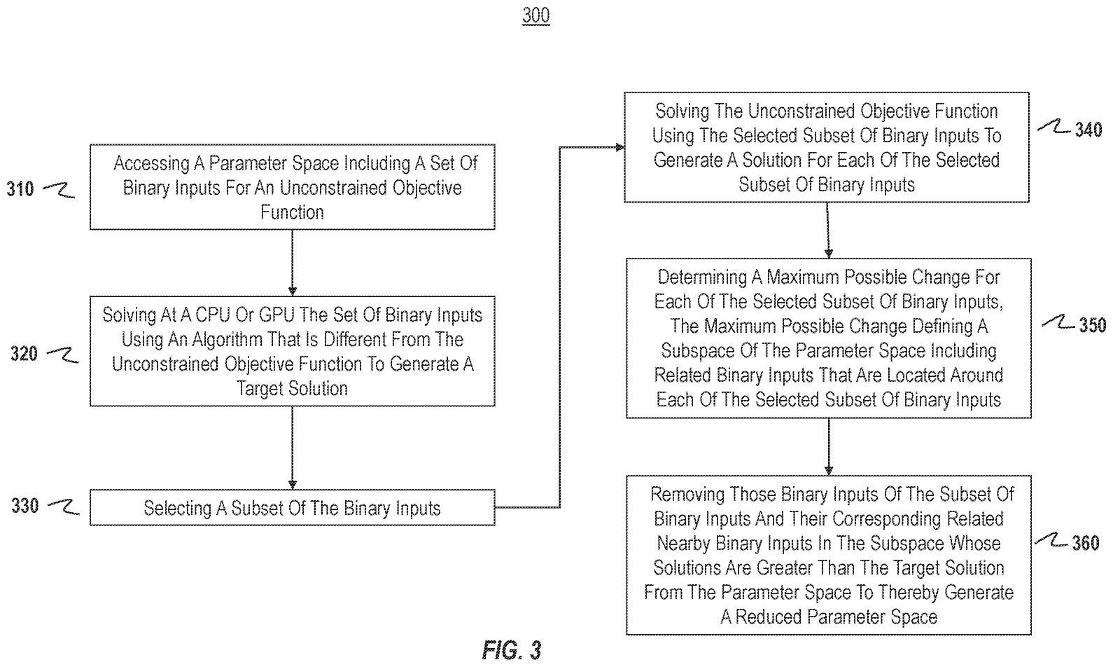

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method 300 for reducing a parameter space for a QUBO problem is disclosed. The method 300 will be described in relation to one or more of the figures previously described, although the method 300 is not limited to any particular embodiment.

The method 300 includes accessing a parameter space including a set of binary inputs for an unconstrained objective function (310). For example, as previously described the parameter space 225 includes the binary inputs 226,227, and 228. This is accessed by the parameter reducing engine 240.

The method 300 includes solving at a CPU or GPU the set of binary inputs using an algorithm that is different from the unconstrained objective function to generate a target solution (320). For example, as previously described the target solution generator 230 generates the target solution 235.

The method 300 includes selecting a subset of the binary inputs (330). For example, as previously described the function evaluator 241 selects a subset of the binary inputs 226,227, and 228.

The method 300 includes solving the unconstrained objective function using the selected subset of binary inputs to generate a solution for each of the selected subset of binary inputs (340). For example, as previously described the function evaluator 241 uses the selected binary inputs to generate the solutions 226A, 227A, and 228A.

The method 300 includes determining a maximum possible change for each of the selected subset of binary inputs, the maximum possible change defining a subspace of the parameter space including related binary inputs that are located around each of the selected subset of binary inputs (350). For example, as previously described the analysis engine 242 analyzes the solutions 226A, 227A, and 228A to determine the maximum possible change. This defines the parameter subspaces 226B, 227B, and 228B that include the related binary inputs located around the binary inputs 226, 227, and the additional binary inputs 228.

The method 300 includes removing those binary inputs of the subset of binary inputs and their corresponding related nearby binary inputs in the subspace whose solutions are greater than the target solution from the parameter space to thereby generate a reduced parameter space (360). For example, as previously described the binary inputs and the related binary inputs whose solutions are greater than the target solution are removed and the reduced parameter space 245 is generated.

### D. Further Example Embodiments

Following are some further example embodiments of the invention. These are presented only by way of example and are not intended to limit the scope of the invention in any way.

Embodiment 1. A method, comprising: accessing a parameter space including a set of binary inputs for an unconstrained objective function; solving at a CPU or GPU the set of binary inputs using an algorithm that is different from the unconstrained objective function to generate a target solution; selecting a subset of the binary inputs; solving the unconstrained objective function using the selected subset of binary inputs to generate a solution for each of the selected subset of binary inputs; determining a maximum possible change for each of the selected subset of binary inputs, the maximum possible change defining a subspace of the parameter space including related binary inputs that are located around each of the selected subset of binary inputs; and removing those binary inputs of the subset of binary inputs and their corresponding related nearby binary inputs in the subspace whose solutions are greater than the target solution from the parameter space to thereby generate a reduced parameter space.

Embodiment 2. The method of embodiment 1, further comprising: providing the reduced parameter space to an annealing processor; and solving the unconstrained objective function at the annealing processor using the binary inputs that are included in the reduced parameter space.

Embodiment 3. The method of embodiments 1-2, wherein the unconstrained objective function is a quadratic unconstrained binary optimization (QUBO) problem.

Embodiment 4. The method of embodiment 1-3, wherein an amount of the binary inputs that are selected is based on the unconstrained objective function.

Embodiment 5. The method of embodiments 1-4, wherein the subset of the binary inputs is selected randomly.

Embodiment 6. The method of embodiments 1-5, wherein the maximum possible change is determined by determining a maximum change when a bit of a bit array defining the binary inputs is flipped from a 0 to a 1 or from a 1 to a 0.

Embodiment 7. The method of embodiments 1-6, wherein the unconstrained objective function is transformed from a constrained objective function.

Embodiment 8. A system, comprising hardware and/or software, operable to perform any of the operations, methods, or processes, or any portion of any of these, disclosed herein.

Embodiment 9. A non-transitory storage medium having stored therein instructions that are executable by one or more hardware processors to perform operations comprising the operations of any one or more of embodiments 1-7.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, or the like may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

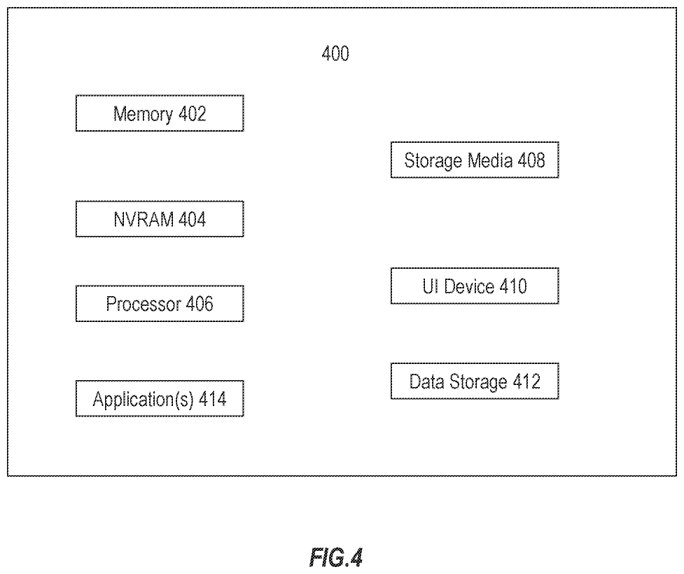

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. Also, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the components of the memory 402 of the physical computing device 400 may take the form of solid-state device (SSD) storage. Also, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
accessing a parameter space including a set of binary inputs for an unconstrained objective function;
solving at a CPU or GPU the set of binary inputs using an algorithm that is different from the unconstrained objective function to generate a target solution;
selecting a subset of the binary inputs;
solving the unconstrained objective function using the selected subset of binary inputs to generate a solution for each of the selected subset of binary inputs;
determining a maximum possible change for each of the selected subset of binary inputs, the maximum possible change defining a subspace of the parameter space including related binary inputs that are located around each of the selected subset of binary inputs; and
removing those binary inputs of the subset of binary inputs and their corresponding related nearby binary inputs in the subspace whose solutions are greater than the target solution from the parameter space to thereby generate a reduced parameter space.

2. The method of claim 1, further comprising:
providing the reduced parameter space to an annealing processor; and
solving the unconstrained objective function at the annealing processor using the binary inputs that are included in the reduced parameter space.

3. The method of claim 1, wherein the unconstrained objective function is a quadratic unconstrained binary optimization (QUBO) problem.

4. The method of claim 1, wherein an amount of the binary inputs that are selected is based on the unconstrained objective function.

5. The method of claim 1, wherein the subset of the binary inputs is selected randomly.

6. The method of claim 1, wherein the maximum possible change is determined by determining a maximum change when a bit of a bit array defining the binary inputs is flipped from a 0 to a 1 or from a 1 to a 0.

7. The method of claim 1, wherein the unconstrained objective function is transformed from a constrained objective function.

8. A non-transitory storage medium having stored therein instructions that are executable by one or more hardware processors to perform operations comprising:
accessing a parameter space including a set of binary inputs for an unconstrained objective function;
solving at a CPU or GPU the set of binary inputs using an algorithm that is different from the unconstrained objective function to generate a target solution;
randomly selecting a subset of the binary inputs;
solving the unconstrained objective function using the selected subset of binary inputs to generate a solution for each of the selected subset of binary inputs;
determining a maximum possible change for each of the selected subset of binary inputs, the maximum possible change defining a subspace of the parameter space including related binary inputs that are located around each of the selected subset of binary inputs; and
removing those binary inputs of the subset of binary inputs and their corresponding related nearby binary inputs in the subspace whose solutions are greater than the target solution from the parameter space to thereby generate a reduced parameter space.

9. The non-transitory storage medium of claim 8, further comprising:
providing the reduced parameter space to an annealing processor; and
solving the unconstrained objective function at the annealing processor using the binary inputs that are included in the reduced parameter space.

10. The non-transitory storage medium of claim 8, wherein the unconstrained objective function is a quadratic unconstrained binary optimization (QUBO) problem.

11. The non-transitory storage medium of claim 8, wherein an amount of the binary inputs that are randomly selected is based on the unconstrained objective function.

12. The non-transitory storage medium of claim 8, wherein the subset of the binary inputs is selected randomly.

13. The non-transitory storage medium of claim 8, wherein the maximum possible change is determined by determining a maximum change when a bit of a bit array defining the binary inputs is flipped from a 0 to a 1 or from a 1 to a 0.

14. The non-transitory storage medium of claim 8, wherein the unconstrained objective function is transformed from a constrained objective function.

15. A computing system comprising:
one or more processors;
one or more non-transitory computer readable storage medium having stored therein instructions that, when executed by the one or more processors, cause the computing system to perform the following:
access a parameter space including a set of binary inputs for an unconstrained objective function;
solve at a CPU or GPU the set of binary inputs using an algorithm that is different from the unconstrained objective function to generate a target solution;
randomly select a subset of the binary inputs;
solve the unconstrained objective function using the selected subset of binary inputs to generate a solution for each of the selected subset of binary inputs;
determine a maximum possible change for each of the selected subset of binary inputs, the maximum possible change defining a subspace of the parameter space including related binary inputs that are located around each of the selected subset of binary inputs; and
remove those binary inputs of the subset of binary inputs and their corresponding related nearby binary inputs in the subspace whose solutions are greater than the target solution from the parameter space to thereby generate a reduced parameter space.

16. The computing system of claim 15, further caused to:
provide the reduced parameter space to an annealing processor; and
solve the unconstrained objective function at the annealing processor using the binary inputs that are included in the reduced parameter space.

17. The computing system of claim 15, wherein the unconstrained objective function is a quadratic unconstrained binary optimization (QUBO) problem.

18. The computing system of claim 15, wherein an amount of the binary inputs that are randomly selected is based on the unconstrained objective function.

19. The computing system of claim 15, wherein the subset of the binary inputs is selected randomly.

20. The computing system of claim 15, wherein the maximum possible change is determined by determining a maximum change when a bit of a bit array defining the binary inputs is flipped from a 0 to a 1 or from a 1 to a 0.
